(19) United States
(12) Patent Application Publication
(10) Pub. No.: US 2012/0122666 A1
(43) Pub. Date: May 17, 2012

(54) FUEL CELL ELECTRODE CATALYST, METHOD FOR EVALUATING PERFORMANCE OF OXYGEN-REDUCING CATALYST, AND SOLID POLYMER FUEL CELL COMPRISING THE FUEL CELL ELECTRODE CATALYST

(76) Inventors: Yukiyoshi Ueno, Shizuoka (JP); Hirofumi Iisaka, Aichi (JP)

(21) Appl. No.: 12/672,282

(22) PCT Filed: Aug. 8, 2008
(86) PCT No.: PCT/JP08/64605

§ 371 Date: Feb. 5, 2010

(30) Foreign Application Priority Data
Aug. 9, 2007 (JP) 2007-208400

(51) Int. Cl. B01J 27/051; G01N 27/26; B01J 27/00

(52) U.S. Cl. 502/220; 502/100; 205/782

(57) ABSTRACT

According to the present invention, a fuel cell electrode catalyst comprising molybdenum, a different transition metal element, and a chalcogen element and having high activity is provided with an index for performance evaluation that is useful for Ogood catalyst design. Also, a fuel cell electrode catalyst is provided, such catalyst comprising at least one transition metal element (M1), molybdenum (Mo), and at least one chalcogen element (X), wherein the value of (Mo—O coordination number)/[(Mo—O coordination number)+(Mo—X coordination number)] is 0.44 to 0.66.

### TECHNICAL FIELD

The present invention relates to a fuel cell electrode catalyst comprising at least one transition metal element and at least one chalcogen element, which can replace a conventional platinum catalyst, a method for evaluating performance of an oxygen-reducing catalyst, and a solid polymer fuel cell comprising such fuel cell electrode catalyst.

### BACKGROUND ART

Anode catalysts used for polymer electrolyte fuel cells are mainly platinum and platinum-alloy-based catalysts. Specifically, catalysts in which a platinum-containing noble metal is supported by carbon black have been used. In terms of practical applications of polymer electrolyte fuel cells, one problem relates to the cost of materials. A means to solve such problem involves reduction in the platinum content.

Meanwhile, it has been known that when oxygen (O₂) is electrolytically reduced, superoxide is generated as a result of one-electron reduction, hydrogen peroxide is generated as a result of two-electron reduction, or water is generated as a result of four-electron reduction. When voltage reduction occurs for some reason in a fuel cell stack using, as an electrode, a platinum or platinum-based catalyst, four-electron reduction performance deteriorates, resulting in two-electron reduction. Accordingly, hydrogen peroxide is generated, causing MEA deterioration.

Recently, low-cost fuel cell catalysts have been developed via a reaction that produces water as a result of four-electron reduction of oxygen, which will result in elimination of the need for expensive platinum catalysts. Non-Patent Document 1 described below discloses that a catalyst comprising a chalcogen element is excellent in terms of four-electron reduction performance and suggests that such catalyst be applied to fuel cells.

Likewise, Patent Document 1 described below discloses, as a platinum (Pt) catalyst substitute, an electrode catalyst comprising at least one transition metal and a chalcogen. An example of a transition metal is Ru and an example of a chalcogen is S or Se. It is also disclosed that, in such case, the Ru : Se molar ratio is from 0.5:1 to 2:1 and the stoichiometric number “n” of (Ru)nSe is 1.5 to 2.

Further, Patent Document 2 described below discloses, as a Pt catalyst substitute, a fuel cell catalyst material comprising a transition metal that is either Fe or Ru, an organic transition metal complex containing nitrogen, and a chalcogen component such as S.

In addition, Non-Patent Document 1 described below discloses an Mo—Ru—Se ternary electrode catalyst and a method for synthesizing the same.

Further, Non-Patent Document 2 described below discloses Ru—S, Mo—S, and Mo—Ru—S binary and ternary electrode catalysts and methods for synthesizing the same.

Furthermore, Non-Patent Document 3 described below discloses Ru—Mo—S and Ru—Mo—Se ternary chalcogenide electrode catalysts.

### Patent Document 1: JP Patent Publication (Kohyo) No. 2001-502467 A

### Patent Document 2: JP Patent Publication (Kohyo) No. 2004-532734 A

### Non-Patent Document 1: Electrochimica Acta, vol. 39, No. 11/12, pp. 1647-1653, 1994

Non-Patent Document 2: J. Chem. Soc., Faraday Trans., 1996, 92 (21), 4311-4319

### Non-Patent Document 3: Electrochimica Acta, vol. 45, pp. 4237-4250, 2000

### DISCLOSURE OF THE INVENTION

### Problem to be Solved by the Invention

The catalysts disclosed in Patent Document 1 and Non-Patent Documents 1, 2, and 3 are insufficient in terms of four-electron reduction performance. Therefore, the development of high-performance catalysts and of an index for performance evaluation that is useful for high-performance catalyst design has been awaited.

### Means for Solving Problem

The present inventors have found that, in the case of a fuel cell electrode catalyst comprising a transition metal element, molybdenum, and a chalcogen element, the ratio of the coordination number of one specific element to that of the other is closely related to the oxygen reduction performance of such catalyst. Further, they have found that the above problem can be solved by designating the coordination number ratio as an index for performance evaluation that is useful for catalyst design. This has led to the completion of the present invention.

Specifically, in a first aspect, the present invention relates to a fuel cell electrode catalyst comprising at least one transition metal element (M1), molybdenum (Mo), and at least one chalcogen element (X), characterized in that the value of (Mo—O coordination number)/[(Mo—O coordination number +Mo—X coordination number)] is 0.44 to 0.66.

Regarding the fuel cell electrode catalyst of the present invention, which comprises at least one transition metal element (M1), molybdenum (Mo), and at least one chalcogen element (X), it is preferable that a transition metal element be at least one selected from the group consisting of ruthenium (Ru), osmium (Os), cobalt (Co), rhodium (Rh), iridium (Ir), iron (Fe), nickel (Ni), titanium (Ti), palladium (Pd), rhenium (Re), and tungsten (W), and that a chalcogen element be at least one selected from the group consisting of sulfur (S), selenium (Se), and tellurium (Te). A preferred example of a catalyst comprising a combination of the above components is an Ru—Mo—S3 ternary catalyst in which a transition metal element (M1) is ruthenium (Ru) and a chalcogen element (X) is sulfur (S).

Herein, the “Mo—O coordination number” and the “Mo—X coordination number” of an electrode catalyst are determined not only based on the composition ratio of molybdenum to a chalcogen element but also based on the nature of a crystal of catalyst particles comprising individual elements, the particle size thereof, and the like. In addition, it is possible to change crystallographic activity, particle-size-dependent activity, and the like of such catalyst particles mainly based on conditions of baking after catalyst preparation.

In a second aspect, the present invention relates to a method for evaluating performance of an oxygen-reducing catalyst represented by a fuel cell electrode catalyst, characterized in that the value of (Mo—O coordination number)/[(Mo—O coordination number)+(Mo—X coordination number)] is 0.44 to 0.66 is used as an index of catalyst performance for a fuel cell electrode catalyst comprising at least one transition metal element (M1), molybdenum (Mo), and at least one chalcogen element (X). Accordingly, such method is useful in the design of an excellent oxygen-reducing catalyst.

Specifically, an oxygen-reducing catalyst can receive an excellent evaluation when the value of (Mo—O coordination number)/[(Mo—O coordination number)+(Mo—X coordination number)] is 0.44 to 0.66.

As described above, it is preferable that a transition metal element be at least one selected from the group consisting of ruthenium (Ru), osmium (Os), cobalt (Co), rhodium (Rh), iridium (Ir), iron (Fe), nickel (Ni), titanium (Ti), palladium (Pd), rhenium (Re), and tungsten (W), and that a chalcogen element be at least one selected from the group consisting of sulfur (S), selenium (Se), and tellurium (Te). As described above, a preferred example of a catalyst comprising a combination of the above components is an Ru—Mo—S3 ternary catalyst in which a transition metal element (M1) is ruthenium (Ru) and a chalcogen element (X) is sulfur (S).

In a third aspect, the present invention relates to a solid polymer fuel cell comprising the above fuel cell electrode catalyst.

### Effects of the Invention

The fuel cell electrode catalyst of the present invention has a higher level of four-electron reduction performance and higher activity than a conventional transition metal-chalcogen element-based catalyst, and thus it can serve as a platinum catalyst substitute.

In addition, the technique for obtaining the value of (Mo—O coordination number)/[(Mo—O coordination number)+(Mo—X coordination number)] used in the present invention is widely useful in the design of oxygen-reducing catalysts.

### BRIEF DESCRIPTION OF THE DRAWINGS

FIG. 1 shows the oxygen reduction current value of RuMoS/C and that of RuS/C.

FIG. 2 shows structural analysis results for Mo-containing chalcogenide obtained via EXAFS.

FIG. 3A, 3B, 3C show TEM images (FIG. 3A, 3B) of an Mo—O portion of Mo-containing chalcogenide obtained via TEM and an X-ray diffraction image (FIG. 3C) of the Mo—O portion.

FIG. 4A, 4B, 4C show TEM images (FIG. 4A, 4B) of an Mo—S portion of Mo-containing chalcogenide obtained via TEM and an X-ray diffraction image (FIG. 4C) of the Mo—S portion.

FIG. 5 shows structural analysis results for Mo-containing chalcogenide (treated under different heat treatment conditions) obtained via EXAFS.

FIG. 6 shows results obtained by a rotating disk electrode (RDE) evaluation method whereby the above catalyst materials (treated under different heat treatment conditions) were evaluated in relation to the oxygen reduction performance of Mo-containing chalcogenide.

FIG. 7 shows the correlation between the value of (Mo—O coordination number)/[(Mo—O coordination number)+(Mo—X coordination number)] and the oxygen reduction current value.

### BEST MODE FOR CARRYING OUT THE INVENTION

Hereinafter, the present invention is described in more detail with reference to the Examples and the Comparative Examples.

### [Catalyst Preparation]

Ketjen Black (trade name) was used as a carbon carrier. Ruthenium carbonyl, molybdenum carbonyl, and sulfur were heated at 140° C. in the presence of argon, followed by cooling. Thereafter, the resultant was washed with acetone and filtered. The obtained filtrate containing RuMoS/C (Ru:Mo:S=5:1:5; 60 wt %) was baked at 350° C. for 2 hours. Thus, a catalyst was prepared.

For comparison, RuS/C (Ru:S=1:1; 60 wt %) was prepared in the same manner as that described above, except that molybdenum carbonyl was not used.

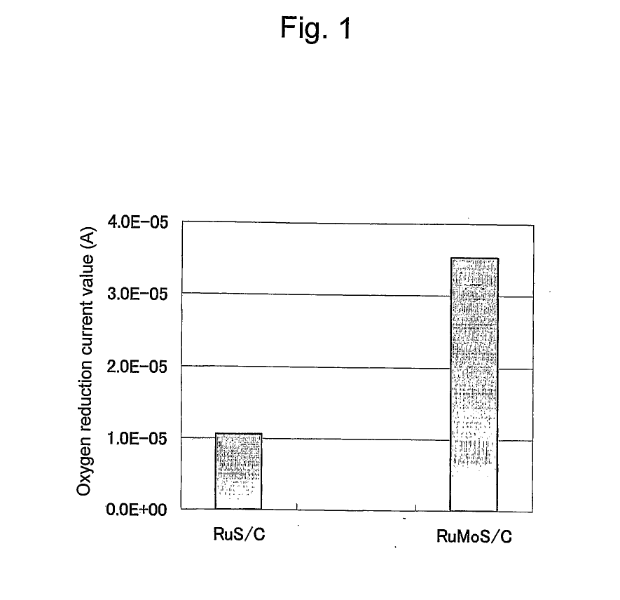

FIG. 1 shows the oxygen reduction current value of RuMoS/C and that of RuS/C. The results shown in FIG. 1 indicate the effects of adding Mo to a chalcogenide-based catalyst.

### [Structural Analysis]

The above catalyst materials were subjected to structural analysis via EXAFS and TEM.

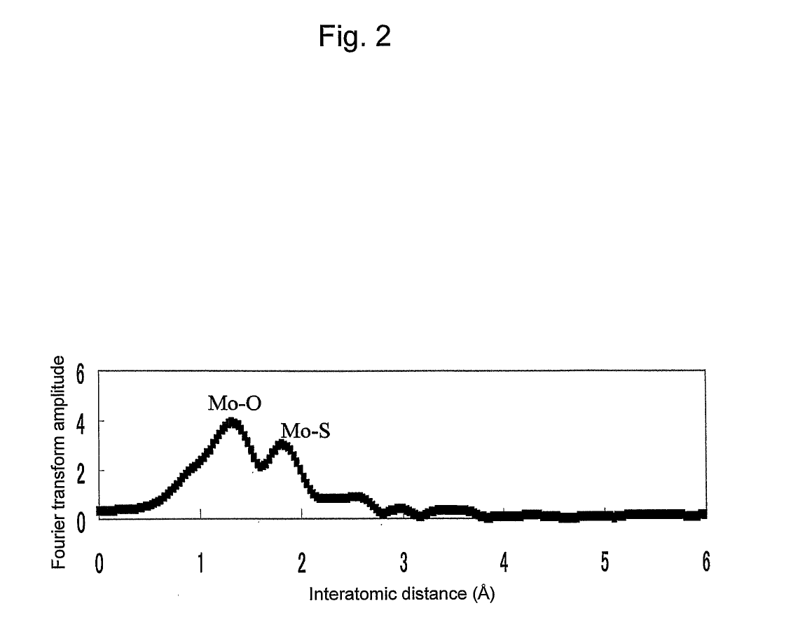

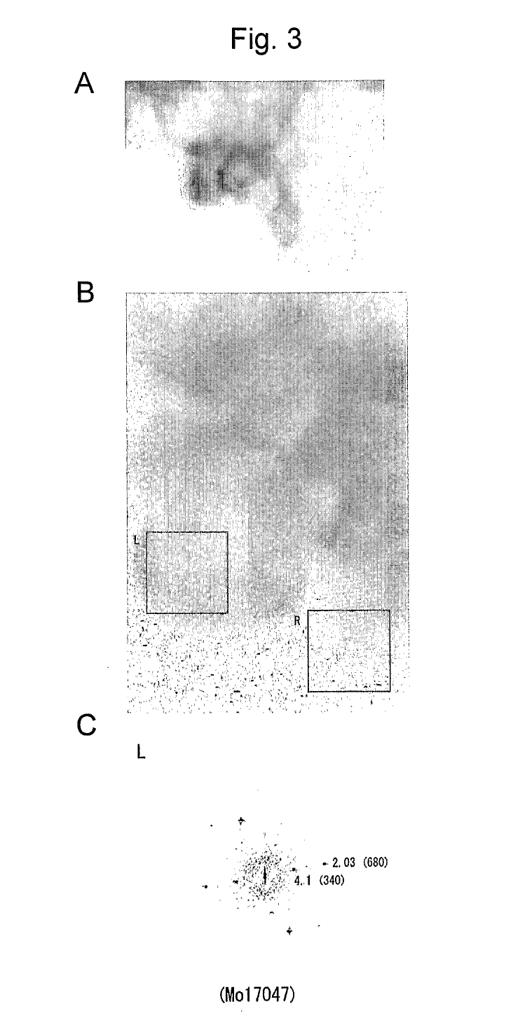

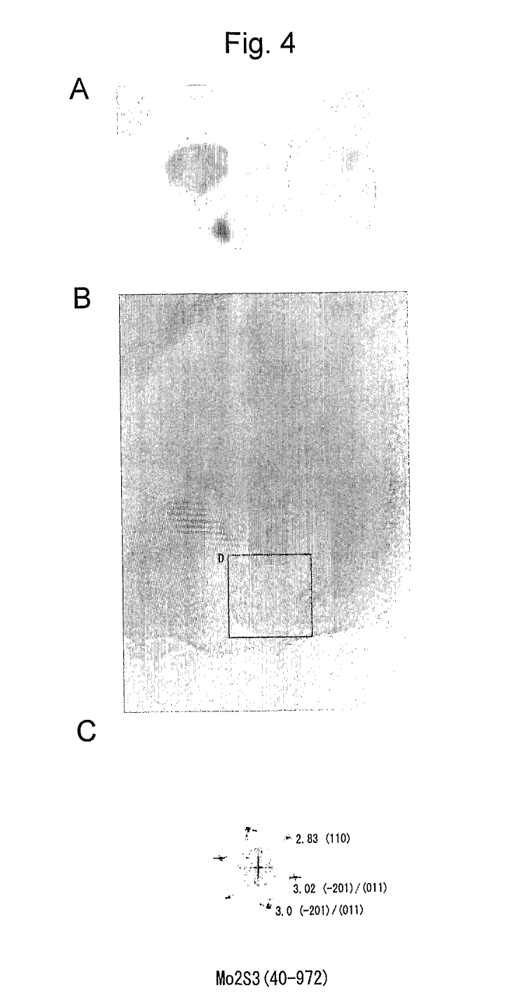

FIG. 2 shows structural analysis results for Mo-containing chalcogenide obtained via EXAFS (extend X-ray absorption fine structure). FIG. 3A, 3B, 3C show TEM images (FIG. 3A, 3B) of an Mo—O portion of Mo-containing chalcogenide obtained via TEM and an X-ray diffraction image (FIG. 3C) of the Mo—O portion. Likewise, FIG. 4A, 4B, 4C show TEM images (FIG. 4A, 4B) of an Mo—S portion of Mo-containing chalcogenide obtained via TEM and an X-ray diffraction image (FIG. 4C) of the Mo—S portion.

As a result of structural analysis via EXAFS and TEM, a chalcogenide catalyst material containing Mo and Ru was found to comprise an Mo oxide (Mo—O) and an Mo sulfide (Mo—S).

[Structural Analysis and Performance Evaluation of Catalyst Materials Treated under Different Heat Treatment Conditions]

Catalyst materials (Ru:Mo:S=5:1:5 for each) were prepared in the same manner as that described above, provided that each material was treated under a different heat treatment condition (300° C.×1 h, 350° C.×1 h, 500° C.×1 h, or 350° C.×2 h).

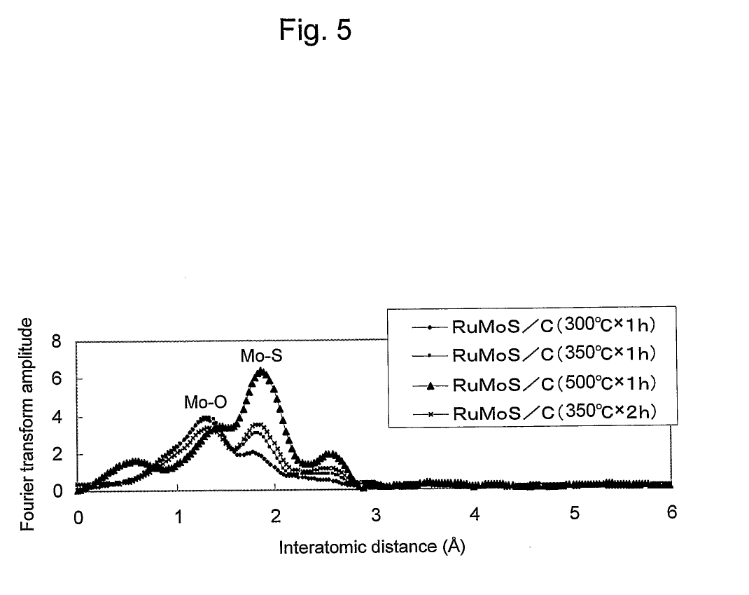

FIG. 5 shows structural analysis results for Mo-containing chalcogenide (treated under different heat treatment conditions) obtained via EXAFS. It is understood that there are variations in the results (shown in FIG. 5) derived from Mo oxide (Mo—O) and Mo sulphide (Mo—S).

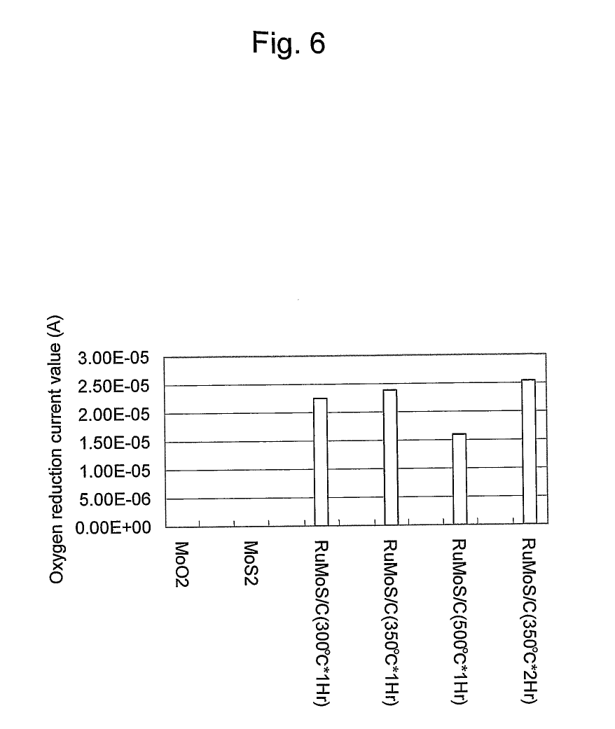

FIG. 6 shows results obtained by a rotating ring-disk electrode (RDE) evaluation method whereby the above catalyst materials (treated under different heat treatment conditions) were evaluated in relation to the oxygen reduction performance of Mo-containing chalcogenide. Note that MoO₂ and MoS₂ were used as reference substances.

The correlation between the following factors was examined: the proportion of Mo oxide (Mo—O) to Mo sulphide (Mo—S) obtained from FIG. 5; and the results of oxygen reduction performance evaluation obtained from FIG. 6. Herein, regarding the Mo oxide (Mo—O) coordination number and the Mo sulphide (Mo—S) coordination number, Fourier transform amplitudes of Mo—O bonds and Mo—S bonds shown in FIG. 5 were calculated to derive the abundances thereof.

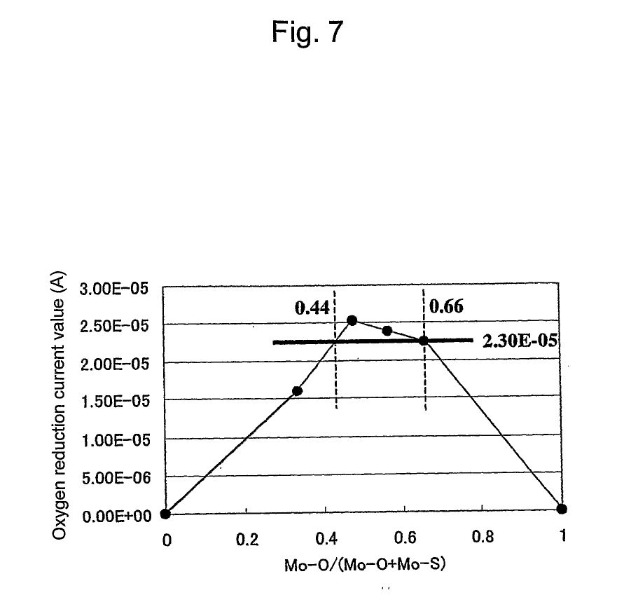

FIG. 7 shows the correlation between the value of (Mo—O coordination number)/[(Mo—O coordination number)+(Mo—X coordination number)] and the oxygen reduction current value. Based on the results shown in FIG. 7, it is understood that an excellent oxygen-reducing catalyst is obtained when the value of (Mo—O coordination number)/[(Mo—O coordination number)+(Mo—X coordination number)] is 0.44 to 0.66.

### INDUSTRIAL APPLICABILITY

The fuel cell electrode catalyst of the present invention has a high level of four-electron reduction performance and high activity, and thus it can serve as a platinum catalyst substitute. In addition, the technique for obtaining the value of (Mo—O coordination number)/[(Mo—O coordination number)+(Mo—X coordination number)] used in the present invention is widely useful in the design of oxygen-reducing catalysts. Therefore, the present invention contributes to the practical and widespread use of fuel cells.

1. A fuel cell electrode catalyst comprising at least one transition metal element (M1), molybdenum (Mo), and at least one chalcogen element (X), wherein the value of (Mo—O coordination number)/[(Mo—O coordination number)+(Mo—X coordination number)] is 0.44 to 0.66.

2. The fuel cell electrode catalyst according to claim 1, wherein the transition metal element (M1) is ruthenium (Ru) and the chalcogen element (X) is sulfur (S).

3. A method for evaluating performance of an oxygen-reducing catalyst, wherein the value of (Mo—O coordination number)/[(Mo—O coordination number)+(Mo—X coordination number)] is used as an index of catalyst performance for a fuel cell electrode catalyst comprising at least one transition metal element (M1), molybdenum (Mo), and at least one chalcogen element (X).

4. The method for evaluating performance of an oxygen-reducing catalyst according to claim 3, wherein the value of (Mo—O coordination number)/[(Mo—O coordination number)+(Mo—X coordination number)] is 0.44 to 0.66.

5. The method for evaluating performance of an oxygen-reducing catalyst according to claim 4, wherein the transition metal element (M1) is ruthenium (Ru) and the chalcogen element (X) is sulfur (S).

6. A solid polymer fuel cell, which comprises the fuel cell electrode catalyst according to claim 1.
